(19) United States
(12) Patent Application Publication
(10) Pub. No.: US 2007/0007135 A1
(43) Pub. Date: Jan. 11, 2007

(54) Methods for the selective absorption of oxygen from a gas mixture

(76) Inventors: Rudolf Gheczy, WIEN (AT); Johann Otonicar, Wien (AT); Wolfgang Wesner, Wien (AT)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/565,765

(22) PCT Filed: Jul. 22, 2004
(86) PCT No.: PCT/AT04/00263

§ 371 Date: Jan. 24, 2006

(30) Foreign Application Priority Data
Jul. 24, 2003 (AT) A 1170/2003

(51) Int. Cl. G01N 27/26

(52) U.S. Cl. 204/424

(57) ABSTRACT

The invention relates to a method for the selective absorption of oxygen from a gas mixture, preferably ambient air, into a liquid medium, followed by releasing of the oxygen so as to make it available in a concentrated form as a reaction partner for combustion or oxidation reactions, at least one ionic compound which is liquid at the respective processing temperature being used as a medium. The inventive method is characterized in that at least one ionic liquid is used as a medium, which has great reversible oxygen absorbing capacity that is selective towards other gases, particularly nitrogen.

The present invention relates to a method for selectively absorbing oxygen from a gaseous mixture, preferably ambient air, into a liquid medium and subsequently releasing the oxygen to provide it in a concentrated form as a reaction partner for combustion or oxidation reactions.

### BACKGROUND OF THE INVENTION

According to prior art, oxygen can be enriched in situ by means of selective membranes. The selectivity of these membranes is such that oxygen is selectively withdrawn from ambient air. This increases the relative content of oxygen in the residual gas. Due to the process, the effort required for achieving higher purities (lower oxygen contents) increases exponentially. Thus, through these methods, the recovery of technical oxygen is uneconomical.

Furthermore, methods for recovering pure oxygen by freeze separation (Linde process) are known. However, this process is extremely energy consuming, requires extensive technical equipment, and intermediate storage of liquid oxygen is inevitable, which further increases the process costs for providing pure oxygen.

Additionally, oxygen can be enriched by discontinuous loading and deloading of zeolites, molecular sieves or other surface-active substances. Due to the correspondingly high work volume required, such methods are hardly attractive for mobile and industrial use.

Until now, all technical combustion processes have been based on the use of air as oxygen donor, which, particularly in the field of internal combustion engines, has led to the formation of disagreeable by-products, i.e. nitrogen oxides NOₓ, as nitrogen represents the major component of air.

In order to solve these NOₓ problems, it was proposed to withdraw oxygen from air by absorption into a liquid medium having high O₂ solvency, followed by transferring the medium containing absorbed oxygen to a desorber where the oxygen is released from the solution and subsequently fed to a combustion process. Based on the fact that perfluorinated hydrocarbons and derivates thereof are capable of selectively absorbing oxygen from gaseous mixtures and releasing it again, F. Luderer describes such a process using perfluorinated hydrocarbons as absorption medium for mobile and stationary combustion systems such as motor vehicle engines and firing plants, cf. German laid-open DE 41 17 829 A1.

In the above publication, the absorption/desorption of O₂ into/from the perfluorinated hydrocarbon(s) is achieved by means of pressure differences which, in the case of motor vehicle engines, are produced by the engine itself. The uptake and release of oxygen from ambient air and into combustion air, respectively, occur through gas-permeable membranes.

In addition to perfluorocarbons, “liquid forms” of iron-chelate complexes, hemoglobines and various cobalt complexes are disclosed as further useful, even if not preferred, liquid media. Modifications of perfluorocarbons forming a weak chemical bond with O₂ in addition to the physical solution of oxygen are also mentioned generally but not described in detail.

These and similar solutions for the problems mentioned above have the disadvantage that perfluorinated hydrocarbons have relatively high vapor pressures. As a consequence, during the sorption process of oxygen into or from the liquid medium/media a fraction proportional to the medium's vapor pressure, as defined by Dalton's law of partial pressures, simultaneously passes the gas-permeable membrane and is lost from the system. This entails economic disadvantages on the one hand, since the medium has to be supplemented periodically, as well as strong environmental pollution by fluorocarbons escaping into the atmosphere on the other hand. In order to overcome these disadvantages, at least in the case of stationary combustion systems, complicated exhaust and recycling systems are required, which again cause considerable costs. Consequently; Luderer's invention is not implementable in this form.

EP 0 306 840 A2 to Air Products and Chemicals Inc. describes a method for separating oxygen from a gaseous mixture by means of alkali metal nitrates, nitrites, oxides, peroxides and superoxides, which absorb oxygen and release it again after adding a transition metal oxide. The salts, preferably mixtures thereof, are used in molten form and absorb and desorb oxygen after redox reaction mechanisms, i.e. exclusively by chemisorption. The molten salts are produced at high process temperatures in the range of 450 to 675° C. and are occasionally highly corrosive.

Therefore, the object of the invention was to improve prior art oxygen enrichment systems in order to overcome the above problems.

### DISCLOSURE OF THE INVENTION

The present invention solves the problems by providing a method for selectively absorbing oxygen from a gaseous mixture, preferably ambient air, into a liquid medium and subsequently releasing the oxygen to provide it in a concentrated form as a reaction partner for combustion or oxidation reactions, wherein at least one ionic compound being liquid at the respective process temperature is used as the medium. The method is characterized in that at least one ionic liquid having a high reversible and—with regard to other gases, especially nitrogen—selective oxygen-uptake capacity is used as the medium.

By direct in situ recovery of oxygen from ambient air, the invention provides for oxygen supply for any combustion and oxidation process without the requirement of storing pure oxygen.

A further possible application is the recovery of oxygen for large-scale combustion systems (power plants, waste incineration, etc.).

A further field of application is the use as oxidizing agent in the chemical industry. Even though oxygen is a much more economical oxidizing agent that air, its use has until now not been possible in many cases because of security reasons (e.g. In refineries, cement plants, etc.)

Specifically, the present invention also provides a solution for the use of oxygen-enriched air in mobile internal combustion engines (cars, trucks) the mentioned at the beginning.

“Ionic liquids” used as media according to the invention have been known per se for quite a while and are mainly used as solvents in organic and inorganic syntheses. In contrast to classical molten salts, ionic liquids are already liquid at relatively low temperatures (<80° C.) and have at the same time relatively low viscosities, i.e. good flowability. Furthermore, in contrast to many classical molten salts, they are not necessarily corrosive.

Furthermore, they are characterized by the fact that they have practically no vapor pressure, i.e. they do not even evaporate in high vacuum. That means that these compounds can be repeatedly equilibrated with the ambient air over a long period of time without considerable evaporation losses. The medium in the above procedure can be a single ionic liquid or a mixture of various such liquids.

By using such ionic liquids as a medium in the inventive method, the operating conditions (temperatures, pressures, equipment materials) for the oxygen absorption/desorption process can be kept in an economical and technically uncomplicated range.

Preferred embodiments of the present invention provide for high selective affinity to oxygen-containing functional groups in the anion and/or cation of the ionic liquids of the media, so that the absorption of oxygen into the medium is promoted. Preferably the at least one ionic liquid comprises a high fraction of perfluorinated residues, the oxygen-uptake capacity of which is used to further increase the affinity to oxygen to be absorbed. Thus, preferred ion combinations are those having incorporated a perfluorinated carbon moiety in the anion and/or the cation.

The inventive substance class of ionic liquids thus offers a broad range of anionic and cationic components, which can be combined within broad limits. Limitations mainly relate to the stability of the respective substance as well as its liquidus range, which has to be adjusted to the respective process temperature.

In preferred embodiments, cations for the synthesis of ionic liquids according to the present invention may be substituted ammonium, phoshonium and pyridinium ions. The substitutions of the residues allow the compound to be adapted to the respective requirements. The selective binding ability of oxygen, and optionally of carbon dioxide (one of the main components of combustion exhaust gases), their temperature and pressure dependence, viscosity, liquidus range and stability (decomposition temperature) are defined mainly by the type and number of residues. If selective binding of oxygen is to be based on the cation, at least one residue has to be able to physically or chemically form a selective bond. Especially preferred is that at least one residue consists of a perfluorinated hydrocarbon.

Unspecific anions may be any conventional compounds for the production of ionic liquids. If specific binding of oxygen via the anion is to be achieved, again a residue has to be introduced, which is capable of physically or chemically forming a selective bond. In preferred embodiments, for example, perfluorinated sulfonic acids R—SO₃⁻ (R=perfluorinated hydrocarbon) can be used. In further embodiments BTA and longer-chain perfluorinated derivates thereof are used.

General and non-limiting examples for combinations of ions usable as ionic liquids are provided below.

| cations | | anions | |
|---|---|---|---|
| 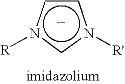 | 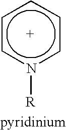 | halogenide BF₄⁻ | (CF₃SO₂)₂N (= “BTA”) NO₃⁻ |
| 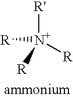 | 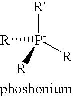 | PF₆⁻CF₃SO₃⁻ | AlCl₄⁻Al₂Cl₇⁻ |

Gas exchange for absorbing oxygen into the ionic liquid can be achieved by directly blowing finely divided air into the medium, by means of trickle-bed contactors in which the medium flows over bodies with large surface areas, by means of membrane contactors in which the medium is separated from gas by a porous membrane, or by means of a combination thereof, the use of membrane contactors, optionally in combination with one of the two alternatives, being preferred according to the present invention.

In order to increase the exchange rate, the air pressure may be increased by means of a compressor or the like.

In order to release oxygen from the loaded ionic liquids, embodiments comprising exchange for CO₂, temperature increase, pressure decrease, exposure to microwaves, catalytic degassing or a combination thereof are suitable.

In preferred embodiments in which the inventive method serves for operating a combustion system for the combustion of fuels with oxygen in a combustion mixture, the oxygen absorbed in the medium is released by being blown out by means of the combustion exhaust gases formed during the combustion (CO₂), constituting the combustion mixture together with these exhaust gases and the fuels. Especially when using the invention for mobile internal combustion engines in motor vehicles with current motor designs, this embodiment is preferred.

The faster release of larger quantities of concentrated oxygen by microwaves or catalytic methods allows highly improved efficiencies at reduced inertia of the engines. In this connection, an adaptation of the cubic capacity as well as special highly oxidation- and temperature-resistant lubricants and construction materials compared to commercial engines are required.

Temperature and pressure changes as measures for improving efficiency may be effected alone or in combination with the above concepts. Temperature variations can be easily achieved by using waste heat of the engine. Pressure changes are caused by preliminary compression during absorption, in order to increase the partial pressure of oxygen, in combination with a pressure decrease during desorption by fuel gas intake.

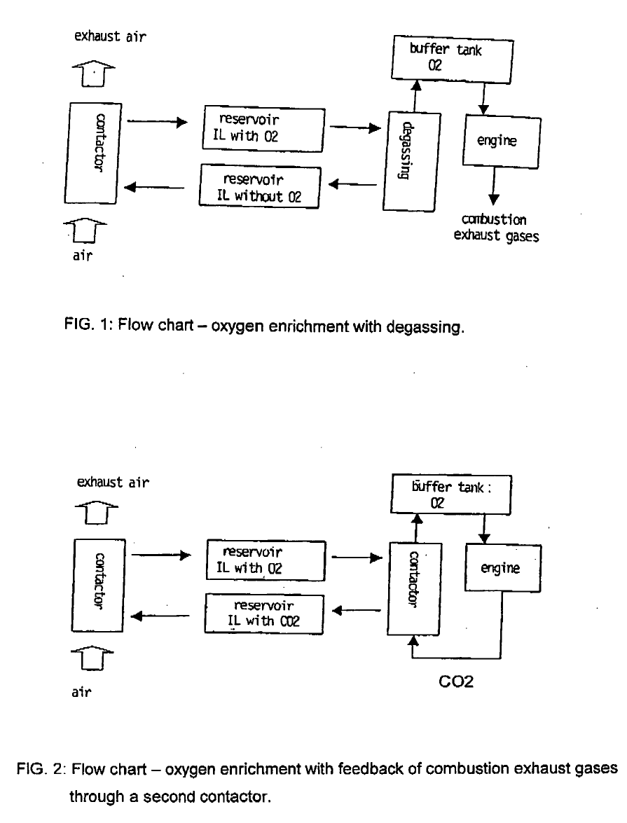

In the following the principle of preferred embodiments of the method of the invention is illustrated by two variations of the operation of an internal combustion engine with reference to the figures, wherein FIG. 1 and FIG. 2 both show flow charts.

Referring to FIG. 1, any way of releasing the absorbed oxygen is carried out before supply to the engine, and referring to FIG. 2, oxygen is blown out by the combustion exhaust gases as described above, i.e. it is displaced from the ionic liquid (“IL”) by CO₂.

1-11. (canceled)

12. A method for providing oxygen in a concentrated form as a reaction partner for combustion or oxidation reactions, said method comprising selectively absorbing oxygen from a gaseous mixture into a liquid medium and releasing the oxygen from the liquid medium, wherein the liquid medium comprises at least one ionic liquid, wherein said ionic liquid has a reversible, and, with regard to nitrogen, a selective oxygen-uptake capacity, said liquid medium maintained at a temperature above the melting point of said the ionic liquid.

13. The method of claim 12, wherein the gaseous mixture is air.

14. The method of claim 12, wherein an ion of the ionic liquid comprises a functional group with selective affinity for oxygen.

15. The method of claim 14, wherein the ion is a cation.

16. The method of claim 14, wherein the ion is an anion.

17. The method of claim 12, wherein the liquid medium comprises perfluorinated residues.

18. The method of claim 12, wherein absorbing oxygen from the gaseous mixture is carried out by passing a finely divided stream of air into the liquid medium.

19. The method of claim 12, wherein absorbing oxygen from the gaseous mixture is carried out by contacting the gaseous mixture and the liquid medium in a trickle-bed contactor.

20. The method of claim 12, wherein absorbing oxygen from the gaseous mixture is carried out by contacting the gaseous mixture and the liquid medium with a porous membrane in a membrane contactor.

21. The method of claim 12, wherein the absorbed oxygen is released from the liquid medium by passing combustion exhaust gases through the liquid medium.

22. The method of claim 12, wherein the absorbed oxygen is released from the liquid medium by exposing the liquid medium to microwaves.

23. The method of claim 12, wherein the absorbed oxygen is released from the liquid medium by catalytically degassing the liquid medium.

24. The method of claim 12, wherein the adsorbed oxygen is released from the liquid medium by increasing the temperature of the liquid medium.

25. The method of claim 12, wherein the absorbed oxygen is released from the liquid medium by decreasing the pressure of the liquid medium.
